(19) United States
(12) Patent Application Publication
(10) Pub. No.: US 2017/0331831 A1
(43) Pub. Date: Nov. 16, 2017

(54) TRUST EVALUATION METHOD AND SYSTEM IN INTERNET OF THINGS

(71) Applicant: Korea Advanced Institute of Science and Technology, Daejeon (KR)

(72) Inventors: HongShik Park, Daejeon (KR); Junseop Ahn, Daejeon (KR); Yong-jun Seo, Daejeon (KR)

(73) Assignee: Korea Advanced Institute of Science and Technology, Daejeon (KR)

(21) Appl. No.: 15/429,109

(22) Filed: Feb. 9, 2017

(30) Foreign Application Priority Data
May 10, 2016 (KR) 10-2016-0056916
Aug. 26, 2016 (KR) 10-2016-0108925

(51) Int. Cl. H04L 29/06

(52) U.S. Cl. CPC H04L 63/102; H04L 63/1433

(57) ABSTRACT

According to one example embodiment, trust evaluation system may include a collection unit collecting internal data and external data; a calculation unit calculating reputation and interactional reciprocity of entity using the internal data or external data and calculating trust of the entity based on the calculated reputation and interactional reciprocity; a process unit determining whether the entity is trustable and access to the entity is permitted by comparing the calculated trust of the entity with a threshold value and reporting to an owner of IoT system a determination result; and an update unit updating the threshold value for the entity based on the determination result.

### CROSS-REFERENCE TO RELATED APPLICATIONS

This application claims priority under 35 U.S.C. §119 to Korean Patent Application No. 10-2016-0056916, filed on May 10, 2016; and Korean Patent Application No. 10- 2016-0108925, filed on Aug. 26, 2016; in the Korean Intellectual Property Office (KIPO), the entire contents of which are incorporated herein by reference.

### BACKGROUND

### Field of the Invention

Example embodiments relate to trust evaluation model and system in IoT (Internet of Things).

### Description of Related Art

Recently IoT (Internet of Things) Technology which shares information by connecting the Internet with all things is emerging. All things of life (for example, home appliances, user devices, and sensors) share and accumulate information by connecting with the Internet, which makes available smart services having intelligence such as smart homes, smart buildings, industrial automation, and remote medical treatment based on the accumulated Big Data.

The development of IoT technology in diverse industry and environment may make hyper-connected society in which a number of IoT devices are connected via IoT network. Therefore, in IoT having Massive connectivity, Security and Privacy problems are worse, along with this, trust problem of terminal and entity may occur. Especially, because of untrusted acts of terminal and entity unnecessary data may be accumulated in IoT system, which may cause malfunction and degradation of services. Therefore, the existing security solutions may not solve the trust problem.

Accordingly, in order that a number of devices which access IoT network provide smart services with right action and useful information, access of untrusted devices is controlled in IoT system and technologies of IoT device authentication and control mechanism are needed to avoid degradation of services.

### SUMMARY

Although interactions occur often for unknown entity and entity is already known, problems occur for whether the entity is trustable in online space in IoT system. In case of untrusted entity, the entity takes action not fatal attack such as virus attack but action to degrade services such as biasing, which is hard to solve with the existing security solutions.

Therefore, it is needed that trust evaluation system to determine whether access to system is permitted with a determination whether it is trustable that unknown, doubtful, and known entities which accumulate data connected with IoT system and system.

Embodiments of the inventive concepts provide a way to control with calculating trust based on reputation and interactional reciprocity of entity accessing to IoT system as a method to control with evaluating trust through real-time collecting and processing data for access of user in IoT system connected with a social network.

According to an aspect of at least one example embodiment, a trust evaluation system may include a collection unit collecting internal data and external data, a calculation unit calculating reputation and interactional reciprocity of entity using the internal data or external data and calculating trust of the entity based on the calculated reputation and interactional reciprocity, a process unit determining whether the entity is trustable and access to the entity is permitted by comparing the calculated trust of the entity with a threshold value and reporting to an owner of IoT system a determination result, and an update unit updating the threshold value for the entity based on the determination result.

The collection unit may include an internal data collection unit collecting internal data based on at least one of a number of access permissions to the IoT system, a number of access permissions of entities of institution, overall number of access attempt of the entities of institution, and overall number of access permissions of the entities of institution.

The collection unit may include an external data collection unit collecting external data based on at least one of overall number of activities of the owner of the IoT system, a number of activities of the owner of each institution of entity, a number of messages sent by the owner to the entity, and a number of messages sent by the entity to the owner.

The calculation unit may include a reputation calculation unit calculating reputation of entity to attempt to access to the IoT system and reputation of institution of entity using the internal data, an interactional reciprocity calculation unit calculating interactional reciprocity for entity to attempt to access to the right of the owner of the IoT system using the external data, and a trust calculation unit calculating trust of the entity based on the calculated reputation and interactional reciprocity.

The process unit may include a trust determination unit determining whether the entity is trustable and access to the entity is permitted by comparing the calculated trust of the entity with a threshold value and report and response unit reporting to the owner of the IoT system the determination result and receiving a feedback on the determination result.

The update unit may update the threshold value for the entity if the determination result is wrong.

According to an aspect of at least one example embodiment, as a computer-readable medium including an instruction that a computer system evaluates the trust, the instruction may include collecting internal data and external data, calculating reputation and interactional reciprocity of entity using the internal data or the external data and calculating trust of the entity based on the calculated reputation and interactional reciprocity, determining whether the entity is trustable and access to the entity is permitted by comparing the calculated trust of the entity with a threshold value and reporting to an owner of IoT system a determination result, and updating the threshold value for the entity based on the determination result and controls the computer system.

According to an aspect of at least one example embodiment, a trust evaluation model may include collecting internal data and external data, calculating reputation and interactional reciprocity of entity using the internal data or the external data and calculating trust of the entity based on the calculated reputation and interactional reciprocity, determining whether the entity is trustable and access to the entity is permitted by comparing the calculated trust of the entity with a threshold value and reporting to an owner of IoT system a determination result, and updating the threshold value for the entity based on the determination result.

The collecting internal data and external data may include collecting internal data based on at least one of a number of access permissions to the IoT system, a number of access permissions of entities of institution, overall number of access attempt of the entities of institution, and overall number of access permissions of the entities of institution.

The collecting internal data and external data may include collecting external data based on at least one of overall number of activities of the owner of the IoT system, a number of activities of the owner of each institution of entity, a number of messages sent by the owner to the entity, and a number of messages sent by the entity to the owner.

The calculating reputation and interactional reciprocity of entity using the internal data or the external data and calculating trust of the entity based on the calculated reputation and interactional reciprocity may include calculating reputation of entity to attempt to access to the IoT system and reputation of institution of entity using the internal data, calculating interactional reciprocity for entity to attempt to access to the right of the owner of the IoT system using the external data, and calculating trust of the entity based on the calculated reputation and interactional reciprocity.

The determining whether the entity is trustable and access to the entity is permitted by comparing the calculated trust of the entity with a threshold value and reporting to the owner of IoT system a determination result may include determining whether the entity is trustable and access to the entity is permitted by comparing the calculated trust of the entity with a threshold value, reporting to the owner of the IoT system the determination result, and receiving a feedback on the determination result.

The updating the threshold value for the entity based on the determination result may include updating the threshold value for the entity if the determination result is wrong.

Embodiments of the inventive concepts may be applied to all of IoT services. Especially, the embodiments of the inventive concepts may be applied to the Door lock of Smart Home, gate of Smart building, or IoT service in sharing economy environment.

The embodiments of the inventive concepts solve problems such as malfunction and degradation of services which are caused by accumulating unnecessary data and untrusted acts due to trust problems of sensor, terminal, and entity and evaluate trust based on reputation and interactional reciprocity. Therefore, trustable IoT ecosystem may be constructed.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing illustrating an IoT environment according to at least one example embodiment;

FIG. 2 is a block diagram illustrating a configuration of a trust evaluation system according to at least one example embodiment;

FIG. 3 is a flowchart illustrating a trust evaluation model of a trust evaluation system according to at least one example embodiment;

FIG. 4 is a detailed flow chart illustrating a trust evaluation model of a trust evaluation system according to at least one example embodiment;

FIG. 5 is an example to apply a trust evaluation system according to at least one example embodiment.

It should be noted that these figures are intended to illustrate the general characteristics of methods and/or structure utilized in certain example embodiments and to supplement the written description provided below. Theses drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings.

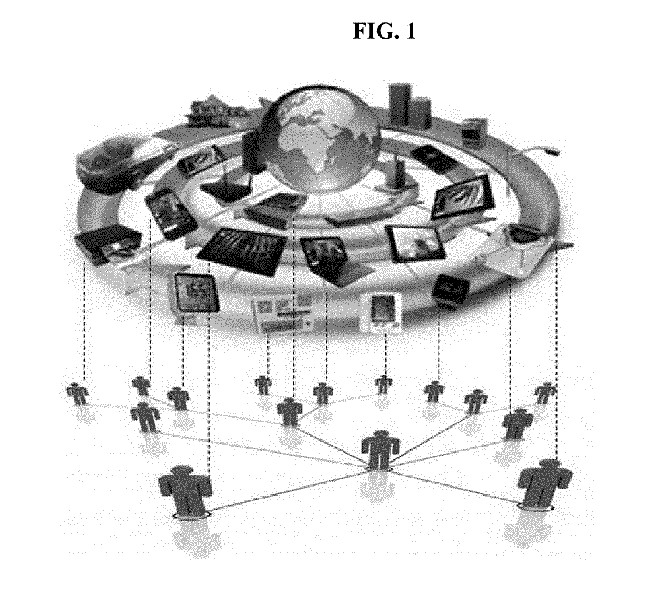

FIG. 1 is a drawing illustrating an IoT environment according to at least one example embodiment.

First of all, platform structure of Internet of Things (IoT) software in a trust evaluation system is described. For example, components of the trust evaluation system may operate using D-platform, P-platform, and M-platform according to a method of IoT communication.

IoT software platform may include D-platform, P-platform, and M-platform, for example.

Here, D-platform indicates software platform installed in IoT devices and P-platform and M-platform may indicate software platform installed respectively or together in server computers.

D-platform which is the abbreviation for Device platform may be installed directly on IoT device or IoT adapter installed in IoT devices, connect with P-platform and M-platform, and connect with smart devices through IoT applications and IoT websites. Here, IoT devices may indicate things applied IoT.

IoT adapters are installed to IoT devices and make things to use IoT communication. IoT adapters include communication module to communicate though at least one of Near Filed Communication, Wi-fi, Ethernet, 3G, and LTE and D-platform installed on IoT adapters provides various functions for IoT communication.

P-platform which is the abbreviation for Planet platform may perform functions such as IoT devices management, user management, IoT devices monitoring, IoT devices search, and the like. In detail, P-platform may register IoT devices by receiving information for IoT devices from IoT service provider. Here, the information for IoT devices may include, for example, device ID, device name, model name, manufacturer, location information, device status information, and the like and address (for example, IP address, and MSISDN) needed when connecting IoT devices.

Also, P-platform may perform authentication for user accessing to register and download IoT applications for IoT services. For user authentication, P-platform may have personal information such as user ID/PW, phone number, and the like.

In addition, P-platform may perform service/developer authentication for authentication of developer developing and registering mash-up services related to IoT and service user using mash-up services.

Furthermore, P-platform may authorize IoT service access of IoT service user by using applications of smart devices (for example, smart phone, tablet, and the like) used as IoT devices.

M-platform which is the abbreviation for Mash-up platform communicating with D-platform may send control command of service user to IoT devices through IoT applications or IoT web pages.

Also, M-platform may register IoT mash-up services developed by mash-up service developer. In other words, mash-up service developer develops IoT mash-up services and registers the services on M-platform. Here, mash-up service developer may develop IoT mash-up services using IoT open API provided from open API server.

IoT devices periodically send data generated by themselves to M-platform, accordingly, by collecting data generated on IoT devices and saving it as log, M-platform may provide various mash-up services to service user.

Also, M-platform performs charging for IoT mash-up service use and may save brief information (for example, ID, IP address, and the like) about IoT devices.

Open API server may perform function to manage and provide open API related to IoT services. In detail, when manufacturing IoT devices, manufacturer of IoT devices develops open API for relevant IoT devices and registers relevant open API on open API server and save it. Then, open API server registers and saves various open API for each IoT device developed by various developers and manages it.

In addition, open API server may provide the saved open API to developers to develop websites relating to IoT services, mash-up sites and applications. Therefore, developers may be provided relevant open API from open API server when developing websites relating to IoT services, mash-up sites, and applications and develop IoT services using provided open API.

For example, if an IoT device manufacturer registers open API providing status information for IoT device (for instance, failures) on open API server, developer may implement function to check IoT device status on websites relating to IoT services, mash-up sites, and applications by searching and using the open API providing status information on open API server.

Meanwhile, IoT service users may use IoT services to access IoT devices directly by using IoT applications downloaded on smart devices which are a type of mobile devices. Here, IoT devices may provide IoT services by connecting smart devices through intermediary of M-platform or connecting directly though P2P (Peer to Peer). In this case, D-platform of IoT devices communicates indirectly through intermediary of M-platform or communicates directly through P2P communication with IoT applications of smart devices.

IoT software platform of the configuration may provide various IoT services by connecting D-platform, P-platform, and M platform with each other.

Likewise, because things and people are connected and it is often that actors of things are people in IoT, not only trust for IoT devices but also trust for people using IoT devices is very important.

Because IoT system provides sophisticated services by connecting with various services such as social network service and the like, not only data by interacting between IoT devices (IoT clients) but also external data provided from connected services may be utilized.

Also, because the meaning of trust in human relationships comes from personal subjective belief expecting that one person does good things for the other person, there is a problem with one authentication node assigning trust level of client nod (IoT devices) according to a standardized authentication test. For same client node, some node may be trusted, but other node may be not trusted. Accordingly, trust evaluation model and system which can show an indicator of personal subjective belief will be described as follows.

According to example embodiments, a trust evaluation system may perform trust evaluation based on trust of person (entity) as actor of IoT devices. Especially, in IoT connecting with external services, trust may be calculated by utilizing external data and internal data of IoT system. Trust evaluation system may show quickly and accurately an indicator of personal subjective belief with changing trust threshold through a way of getting feedback on trust system operation from real-time collecting of external data and trusted main agent.

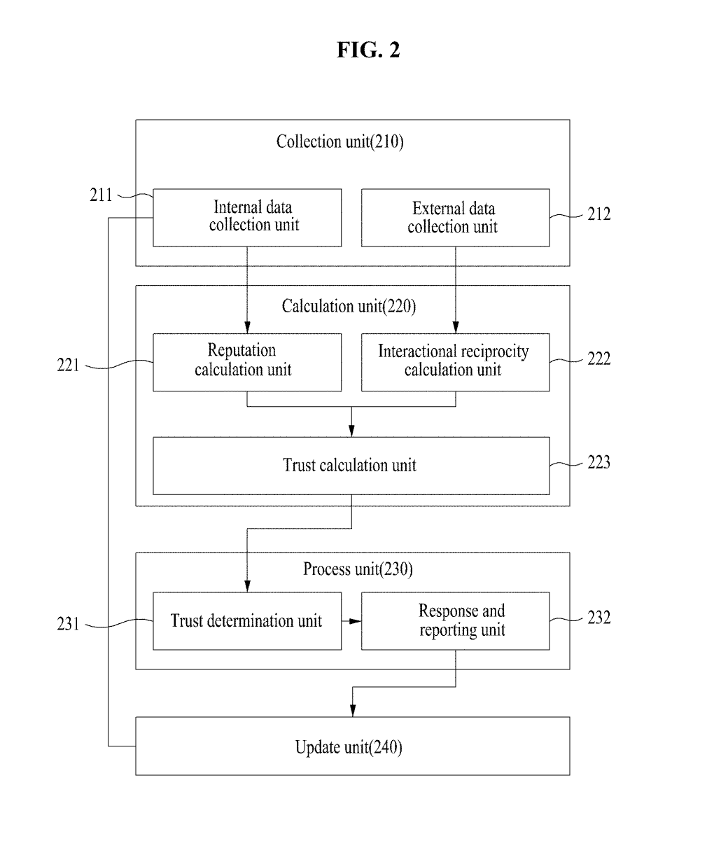

FIG. 2 is a block diagram illustrating a configuration of a trust evaluation system according to at least one example embodiment.

Trust evaluation system may include a collection unit (210), a calculation unit (220), a process unit (230), and an update unit (240).

The collection unit (210) may collect internal data through an internal data collection unit (211) and collect external data through an external data collection unit (212). Here, the internal data may mean historical data of trust evaluation system operation on IoT system and the external data may mean data relating IoT user which is obtainable from social network services connecting with IoT system.

The internal data collection unit (211) may collect internal data based on at least one of a number of access permissions to the IoT system, a number of access permissions of entities of institution, overall number of access attempt of the entities of institution, and overall number of access permissions of the entities of institution.

The external data collection unit (212) may collect external data based on at least one of overall number of activities of the owner of the IoT system, a number of activities of the owner of each institution of entity, a number of messages sent by the owner to the entity, and a number of messages sent by the entity to the owner.

The calculation unit (220) may calculate reputation and interactional reciprocity of entity using the internal data or external data and calculate trust of the entity based on the calculated reputation and interactional reciprocity.

The calculation unit (220) may include a reputation calculation unit (221) calculating reputation of entity to attempt to access to the IoT system and reputation of institution of entity using the internal data, an interactional reciprocity calculation unit (222) calculating interactional reciprocity for entity to attempt to access to the right of the owner of the IoT system using the external data, and a trust calculation unit (223) calculating trust of the entity based on the calculated reputation and interactional reciprocity.

The reputation calculation unit (221) may calculate reputation of user based on the internal data (historical data of IoT trust evaluation system) and if there is no historical data, the reputation calculation unit may calculate initial value of reputation based on the external data. Here, because the reputation calculation unit (221) calculates reputation by utilizing internal data and external data, reputation of user on IoT system is different from reputation used in existing data trust technology. In this regard, as reputation is authority of user defined objectively in one group, if a personal reputation is high, it is likely that the person is trusted, but it is not necessary.

The interactional reciprocity calculation unit (222) may calculate interactional reciprocity between the owner and entity using external data. With regard to trust calculation, the interactional reciprocity calculation unit (222) may set up that by making higher weights for interaction of the owner unlike the existing interactional reciprocity when the owner is more reciprocal to the entity, the trust is higher. At this point, interactional reciprocity means a measure of how much one person interacts with the other person.

The trust calculation unit (223) may calculate trust based on the reputation and the interactional reciprocity. For example, suppose that entity and the owner exchange messages through external service and they have specific group or institution each. Also, when the entity attempts to access to the owner's IoT system, by calculating reputation and interactional reciprocity based on a measure of how much the owner is active on external service, a measure of how many the owner and the entity exchange messages, how many times the entity attempts to access to IoT system of the owner before the predetermined period, and the like. Here, the formula may be changed according to collected data and weights.

The process unit (230) may determine whether the entity is trustable and access to the entity is permitted by comparing the calculated of the entity with a threshold value and report to the owner of the IoT system the determination result. The process unit (230) may include a trust determination unit (231) determining whether the entity is trustable and access to the entity is permitted by comparing the calculated trust of the entity with a threshold and report and response unit (232) reporting to the owner of the IoT system the determination result and receiving a feedback on the determination result.

The update unit (240) may update the threshold value for the entity based on the determination result. The update unit (240) may update the threshold value for the entity if the determination result is wrong.

Because even trust value has subjective determination for trust, trust evaluation system may implement the subject determination of the owner.

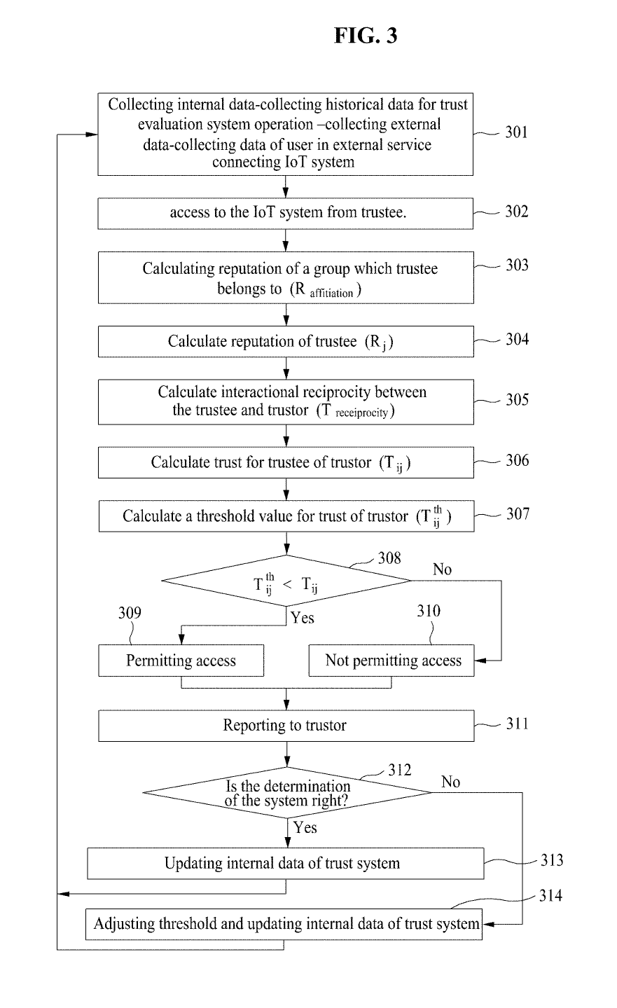

FIG. 3 is a flowchart illustrating trust evaluation model of trust evaluation system according to at least one example embodiment.

In a step (301), trust evaluation system may collect internal data and external data. Here, trust evaluation system may collect Historical data about system operation with internal data and collect data of user in external service connecting with IoT system to external data.

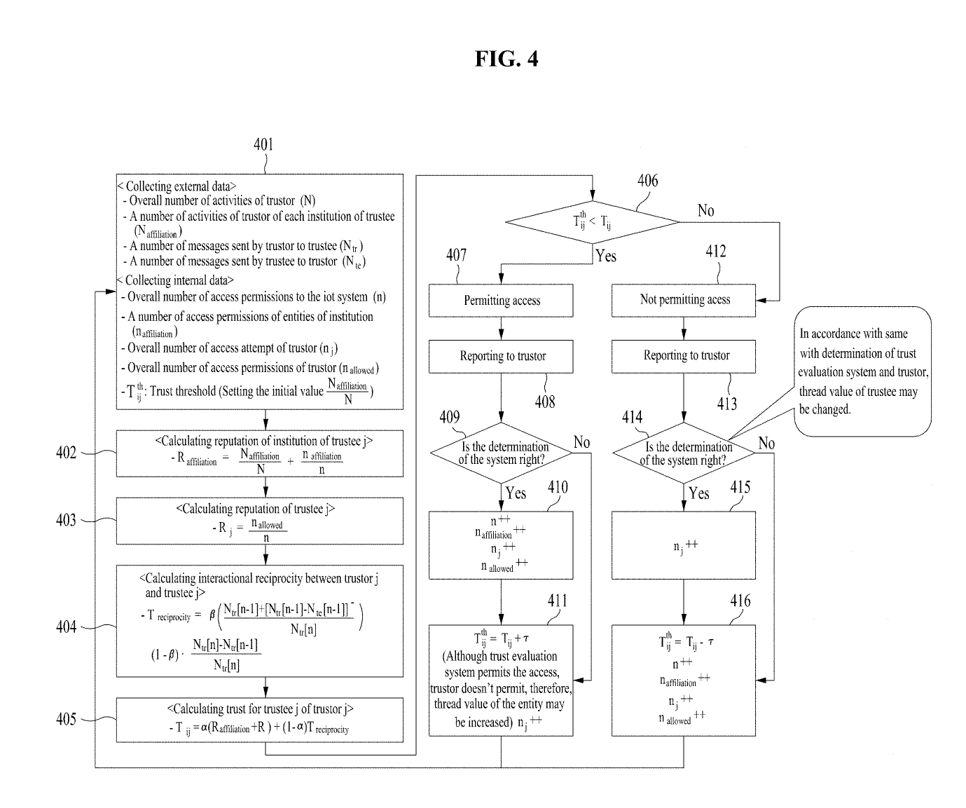

More particularly, referring to FIG. 4, in a step (401), trust evaluation system may collect external data based on at least one of overall number of activities of the owner (Trustor) (N), a number of activities of the owner of each institution of entity (N_{affiliation}), a number of messages sent by the owner to the entity (Nₜᵣ), and a number of messages sent by the entity to the owner (Nₜₑ). Also, trust evaluation system may collect internal data based on at least one of overall number of access permissions to the IoT system (n), a number of access permissions of entities of institution (n_{affiliation}), overall number of access attempt of the owner j (nⱼ) overall number of access of the owner (n_{allowed}). At this point, trust evaluation system may set a threshold for trust as follows.

$${T}_{ij}^{th} \text{:} Trust threshold ( Setting the initial value \frac{{N}_{affilation}}{N} )$$

In a step (302) trust evaluation system may detect access to the IoT system from entity (Trustee).

In a step (303) trust evaluation system may calculate reputation of a group which the entity belongs to (R_{affiliation}). In a step (402) trust evaluation system may calculate reputation of institution of the entity j with the following formula.

$${R}_{affiliation} = \frac{{N}_{affilation}}{N} + \frac{{n}_{affiliation}}{n}$$

Here, if the institution of the entity has not accessed to IoT system, initial value of reputation is calculated based on external data, and then according to a number of access permission, objective reputation may be calculated.

In a step (304) trust evaluation system may calculate reputation of the entity (Rⱼ). In a step (403) trust evaluation system may calculate reputation of the entity j with the following formula.

$${R}_{j} = \frac{{n}_{allowed}}{n}$$

Here, based on how many times the entity is given access permission, reputation of the entity may be calculated.

In a step (305) trust evaluation system may calculate interactional reciprocity between entity and the owner (T_{reciprocity}). In a step (404) trust evaluation system may calculate interactional reciprocity between entity j and the owner l with the following formula.

$${T}_{reciprocity} = β ( \frac{{N}_{tr} [ n - 1 ] + {[ {N}_{tr} [ n - 1 ] - {N}_{te} [ n - 1 ] ]}^{-}}{{N}_{tr} [ n ]} ) + ( 1 - β ) \cdot \frac{{N}_{tr} [ n ] - {N}_{tr} [ n - 1 ]}{{N}_{tr} [ n ]}$$

$$where β \leq \frac{1}{{N}_{tr} [ n - 1 ]}$$

Here, Nₜᵣ[n] means a number of messages sent by the owner to entity until the time n, Nₜᵣ[n−1] means a number of messages sent by the owner to entity until the time n−1, and Nₜₑ[n−1] means a number of messages sent by entity to the owner until the time n−1.

The more a number of messages sent by the owner to entity is many, the more interactional reciprocity may increase and the more a number of messages sent by entity is many comparing to a number of message sent by the owner, the more interactional reciprocity may decrease. In other words, if exchanging messages between the owner and entity makes a balance or the owner send more messages to entity, it may be determined that the owner of IoT system is reciprocity to entity. Also, the more a number of messages recently sent by the owner to entity, the more interactional reciprocity is increase.

In a step (306) trust evaluation system may calculate trust for entity of the owner (Tᵢⱼ). In a step (405) trust evaluation system may calculate trust for entity j of the owner i with the following formula.

Tᵢⱼ=a(R_{affiliation}+Rⱼ)+(1−a)T_{reciprocity}

In a step (307) trust evaluation system may calculate a threshold value for trust of the owner (Tᵢⱼ^{th}).

In a step (308), trust evaluation system may compare with the threshold value and trust of entity. If the threshold value is smaller than trust of the entity, trust evaluation system permits the entity to access to IoT system (309, 407) and if the threshold value is bigger than trust of the entity, trust evaluation system does not permit the entity to access to IoT system (310, 412).

In a step (311), in accordance with permitting the entity to access to IoT system, trust evaluation system reports the determination to the owner and in accordance with not permitting the entity to access to IoT system, trust evaluation system reports the determination to the owner. (408, 413)

In a step (312) trust evaluation system may determine whether the determination that the access of entity to IoT system is permitted or not permitted is right (409). Here, in accordance with same with determination of trust evaluation system and owner, thread value of entity may be changed. If the determination is right, trust evaluation system may update internal data (313, 410). Although trust evaluation system permits the access, the owner doesn't permit, therefore, thread value of the relevant entity may be increased (411). If the determination is not right, trust evaluation system may adjust the threshold value and update internal data (314, 415, and 416).

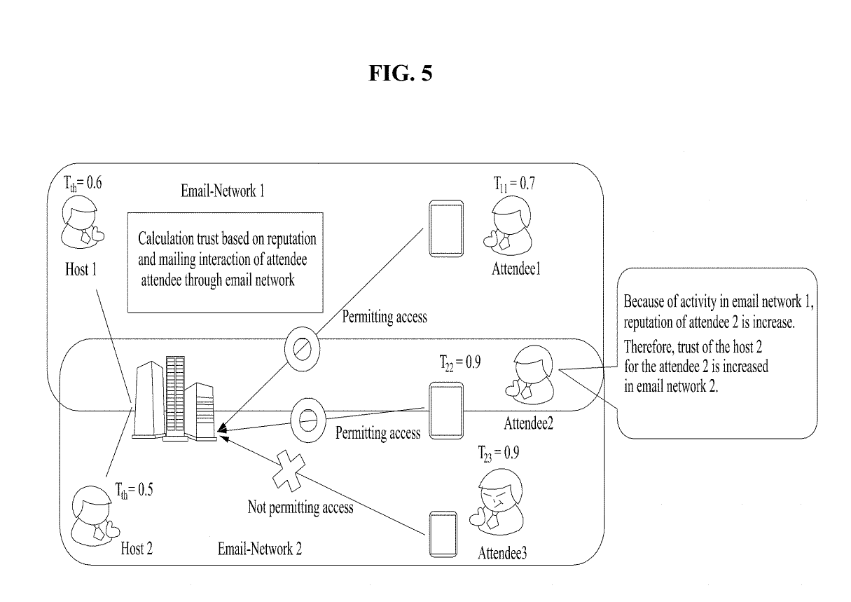

FIG. 5 is an example to apply trust evaluation system according to at least one example embodiment.

The company is most frequented by employees of business partner and the employees of business partner are inconvenient to enter to the company with security problem. Suppose that to solve this problem in-house Smart Entrance system is constructed.

Trust evaluation system calculates interactional reciprocity and trust based on reputation of the business partner and reputation of the employees of the business partner and mailing interaction between the employees of the company and the employees of the business partner and may simplify the entrance process through the constructed Smart Entrance.

Trust evaluation system may permit the access as trust value of attendee 1 is 0.7 and threshold value of host 1 is 0.6 in Email network 1 and may not permit the access as trust value of attendee 3 is 0.4 and threshold value of host 2 is 0.5 in Email network 2.

Trust value of attendee 2 is 0.9 in Email network 2, so the reason that the trust value of attendee 2 is high is that the access of the attendee is permitted many times in Email network 1, therefore, it may be determined that trust of the host 2 for the attendee 2 is increased. However, although reputation of the attendee 2 is high, in case that there is no interactional reciprocity between the host 2 and the attendee 2, the trust may be decreased.

The device described above may implement with hardware components, software components, and/or combination of hardware components and software components. For example, the device and components described in example embodiments, for instance, processors, controllers, ALU (arithmetic logic unit), digital signal processors, microcomputers, FPGA (field programmable gate array), PLU (programmable logic unit), microprocessors, or like other devices executing and responding instructions, may implement using one or more general purpose computers or special purpose computers. Processors may execute one or more software applications working on OS and the above OS. Also, the processors response to the execution of software and may access, save, manipulate, and generate data. For convenient understanding, using one processor is described, but those skilled in the art may know that the processor may include several processing elements and/or several types of processing element. For example, the processor may include several processors or one processor and one controller. Also, like parallel processor, other processing configuration is possible.

Software may include computer program, code, instruction or combination of one or more of these, configure to operate as desired, and instruct independently or collectively to processor. Software and/or data, to be interpreted by processor or to provide instruction or data to the processor, may embody to some types of machine, components, physical devices, virtual equipments, computer storage media or devices. Software is distributed on computer system connecting with network and may be saved or implement as a distributed method.

The methods according to the example embodiments may be recorded in computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of computer-readable media include magnetic media such as hard disks, floppy disks and magnetic tapes; optical media such as CD-ROM, DVD, magneto-optical media such as floptical disks; and especially configured hardware device to store and perform program instructions such as read only memory (ROM), random access memory (RAM), flash memory, and the like. Examples of program instructions include not only machine language code made by a compiler but also high-level language code executed by the computer using an interpreter. The described hardware devices may be to act as one or more software modules in order to perform the operations of example embodiments and the opposite is the same as well.

The foregoing description has been provided for purposes of illustration and description. It is not intended to be exhaustive or to limit the disclosure. Individual elements or features of a particular example embodiment are generally not limited to that particular embodiment, but where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A trust evaluation system, the system comprising:
a collection unit collecting internal data and external data;
a calculation unit calculating reputation and interactional reciprocity of entity using the internal data or external data and calculating trust of the entity based on the calculated reputation and interactional reciprocity;
a process unit determining whether the entity is trustable and access to the entity is permitted by comparing the calculated trust of the entity with a threshold value and reporting to an owner of IoT system a determination result; and
an update unit updating the threshold value for the entity based on the determination result.

2. The trust evaluation system of claim 1, wherein the collection unit comprises
an internal data collection unit collecting internal data based on at least one of a number of access permissions to the IoT system, a number of access permissions of entities of institution, overall number of access attempt of the entities of institution, and overall number of access permissions of the entities of institution.

3. The trust evaluation system of claim 1, wherein the collection unit comprises
an external data collection unit collecting external data based on at least one of overall number of activities of the owner of the IoT system, a number of activities of the owner of each institution of entity, a number of messages sent by the owner to the entity, and a number of messages sent by the entity to the owner.

4. The trust evaluation system of claim 1, wherein the calculation unit comprises:
a reputation calculation unit calculating reputation of entity to attempt to access to the IoT system and reputation of institution of entity using the internal data;
an interactional reciprocity calculation unit calculating interactional reciprocity for entity to attempt to access to the right of the owner of the IoT system using the external data; and
a trust calculation unit calculating trust of the entity based on the calculated reputation and interactional reciprocity.

5. The trust evaluation system of claim 1, wherein the process unit comprises:
a trust determination unit determining whether the entity is trustable and access to the entity is permitted by comparing the calculated trust of the entity with a threshold value; and
report and response unit reporting to the owner of the IoT system the determination result and receiving a feedback on the determination result.

6. The trust evaluation system of claim 1, wherein the update unit updates the threshold value for the entity if the determination result is wrong.

7. As a computer-readable medium including an instruction that a computer system evaluates the trust, the instruction comprising:
collecting internal data and external data;
calculating reputation and interactional reciprocity of entity using the internal data or the external data and calculating trust of the entity based on the calculated reputation and interactional reciprocity;
determining whether the entity is trustable and access to the entity is permitted by comparing the calculated trust of the entity with a threshold value and reporting to an owner of IoT system a determination result; and
updating the threshold value for the entity based on the determination result, and
controls the computer system.

8. A trust evaluation model, the model comprising:
collecting internal data and external data;
calculating reputation and interactional reciprocity of entity using the internal data or the external data and calculating trust of the entity based on the calculated reputation and interactional reciprocity;
determining whether the entity is trustable and access to the entity is permitted by comparing the calculated trust of the entity with a threshold value and reporting to an owner of IoT system a determination result; and
updating the threshold value for the entity based on the determination result.

9. The trust evaluation model of claim 8, wherein the collecting internal data and external data comprises collecting internal data based on at least one of a number of access permissions to the IoT system, a number of access permissions of entities of institution, overall number of access attempt of the entities of institution, and overall number of access permissions of the entities of institution.

10. The trust evaluation model of claim 8, wherein the collecting internal data and external data comprises collecting external data based on at least one of overall number of activities of the owner of the IoT system, a number of activities of the owner of each institution of entity, a number of messages sent by the owner to the entity, and a number of messages sent by the entity to the owner.

11. The trust evaluation model of claim 8, wherein the calculating reputation and interactional reciprocity of entity using the internal data or the external data and calculating trust of the entity based on the calculated reputation and interactional reciprocity comprise:
calculating reputation of entity to attempt to access to the IoT system and reputation of institution of entity using the internal data, calculating interactional reciprocity for entity to attempt to access to the right of the owner of the IoT system using the external data, and calculating trust of the entity based on the calculated reputation and interactional reciprocity.

12. The trust evaluation model of claim 8, wherein the determining whether the entity is trustable and access to the entity is permitted by comparing the calculated trust of the entity with a threshold value and reporting to an owner of IoT system a determination result comprise:
determining whether the entity is trustable and access to the entity is permitted by comparing the calculated trust of the entity with a threshold value, reporting to the owner of the IoT system the determination result and receiving a feedback on the determination result.

13. The trust evaluation model of claim 8, wherein the updating the threshold value for the entity based on the determination result comprises:
updating the threshold value for the entity in case of the determination result which is wrong.
